(19) United States
(12) Patent Application Publication
(10) Pub. No.: US 2026/0202721 A1
(43) Pub. Date: Jul. 16, 2026

(54) CAMERA ASSEMBLY AND ELECTRONIC DEVICE

(71) Applicant: Coretronic Intelligent Robotics Corporation, Hsin-Chu (TW)

(72) Inventors: Chin-Hsien Ting, Hsin-Chu (TW); Wei-Lun Chiang, Hsin-Chu (TW)

(73) Assignee: Coretronic Intelligent Robotics Corporation, Hsin-Chu (TW)

(21) Appl. No.: 19/438,638

(22) Filed: Jan. 1, 2026

(30) Foreign Application Priority Data
Jan. 14, 2025 (TW) 114101396

(51) Int. Cl. G03B 17/56; F16M 11/12; F16M 11/18; H02K 3/04; H02K 41/06

(52) U.S. Cl. CPC G03B 17/561; F16M 11/12; F16M 11/18; H02K 3/04; H02K 41/06

(57) ABSTRACT

A camera assembly includes a first voice coil motor (VCM) module, a first connector, and a camera. The first VCM module includes a first coil and a first magnet. The first coil surrounds a part of a periphery of the first magnet, and is adapted to move along a central axis of the first magnet. The camera is connected to the first coil through the first connector. An electronic device having the camera assembly is also provided.

### CROSS-REFERENCE TO RELATED APPLICATION

This application claims the priority benefit of Taiwan application serial no. 114101396, filed on January 14, 2025. The entirety of the above-mentioned patent application is hereby incorporated by reference herein and made a part of this specification.

### BACKGROUND

### Technical Field

The disclosure relates to a camera assembly and an electronic device.

### Description of Related Art

In a conventional camera assembly, in order to lock a photographic lens in a fixed direction, a multi-axis robotic arm is usually used to grab the photographic lens, for example, by controlling a 2-axis or 3-axis motor to stop rotating or moving, so that the photographic lens maintains a fixed posture. In addition, in motor driving, an effect of vector control and photographic lens control is generally achieved through a mathematical model of the motor matched with a corresponding controller and a high-speed single chip.

In addition, for posture control of the photographic lens, a processing component usually reads a gyroscope angle signal on the photographic lens to calculate a required angle of each of axes and command a driver to control a motor to rotate to this angle, so as to maintain the posture of the photographic lens. However, the conventional camera assembly has the following issues.

1. Servo position control of a brushless motor used is extremely complex, which requires a high computing speed for a single chip.

2. When a carrier carrying the photographic lens becomes smaller, a size of the camera assembly is also required to become smaller. In this way, it is necessary to design a smaller motor, which is difficult and costly. In addition, the smaller motor requires a smaller angle encoder and a smaller driver, which makes a design and fabrication difficult and costly.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a camera assembly, which may have a smaller size and may be controlled by a simpler method.

The disclosure provides an electronic device equipped with a camera assembly that may have a smaller size and may be controlled by a simpler method.

Other objectives and advantages of the disclosure may be further understood from the technical features disclosed herein.

In order to achieve one, a part, or all of the above objectives or other objectives, an embodiment of the disclosure provides a camera assembly, including a first voice coil motor module, a first connector, and a camera. The first voice coil motor module includes a first coil and a first magnet. The first coil surrounds a portion of a periphery of the first magnet, and the first coil is adapted to move along a central axis of the first magnet. The camera is connected to the first coil through the first connector.

In order to achieve one, a part, or all of the above objectives or other objectives, an embodiment of the disclosure provides an electronic device, including a carrier and the aforementioned camera assembly. The camera assembly is disposed on the carrier.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIGS. 1A and 1B are schematic perspective views of a camera assembly when a camera thereof is rotated to two different angles respectively according to an embodiment of the disclosure.

FIG. 2A is a schematic perspective view of a voice coil motor module according to an embodiment of the disclosure.

FIG. 2B is a schematic side view of a voice coil motor module according to another embodiment of the disclosure.

FIG. 2C is a schematic perspective view of a magnet of the voice coil motor module in FIG. 2B.

FIG. 3 is a schematic perspective view of an electronic device according to an embodiment of the disclosure.

FIG. 4 is a schematic perspective view of a camera assembly according to another embodiment of the disclosure.

FIG. 5 is a schematic perspective view of a camera assembly according to still another embodiment of the disclosure.

FIG. 6 is a schematic perspective view of a camera assembly according to yet another embodiment of the disclosure.

FIG. 7 is a schematic perspective view of a camera assembly according to another embodiment of the disclosure.

FIG. 8 is a schematic perspective view of a camera assembly according to still another embodiment of the disclosure.

FIG. 9 is a schematic perspective view of a camera assembly according to yet another embodiment of the disclosure.

FIG. 10 is a schematic view of an electronic device according to another embodiment of the disclosure.

FIG. 11 is a schematic perspective view of a camera assembly according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

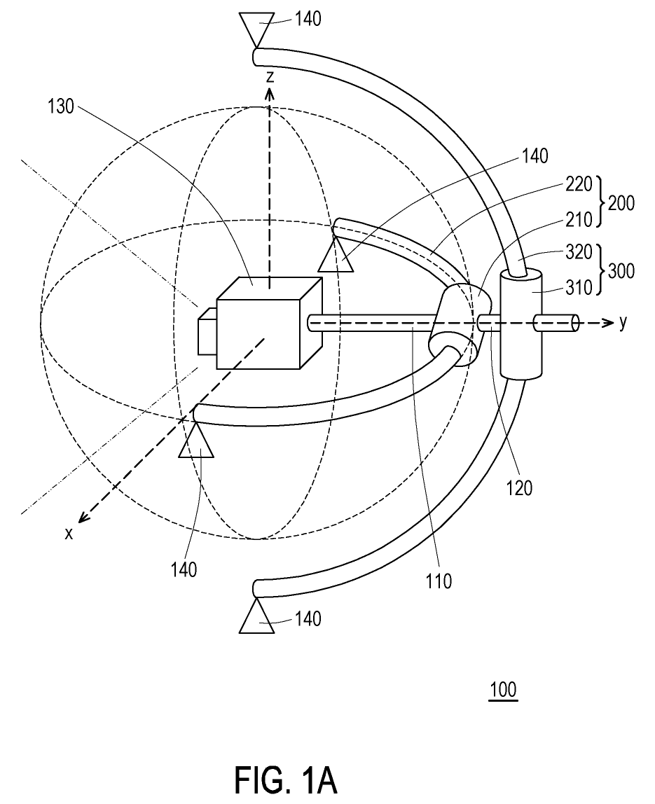

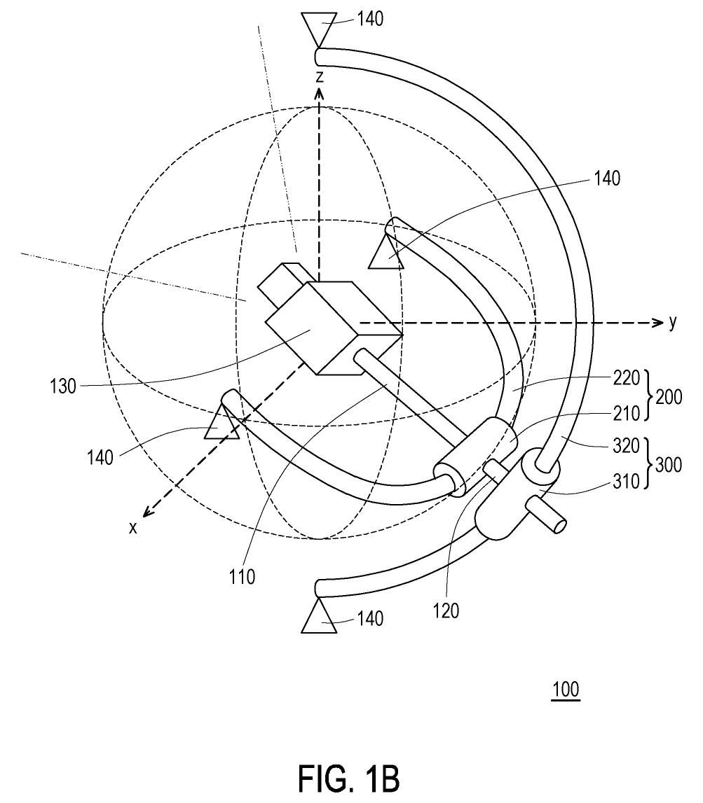

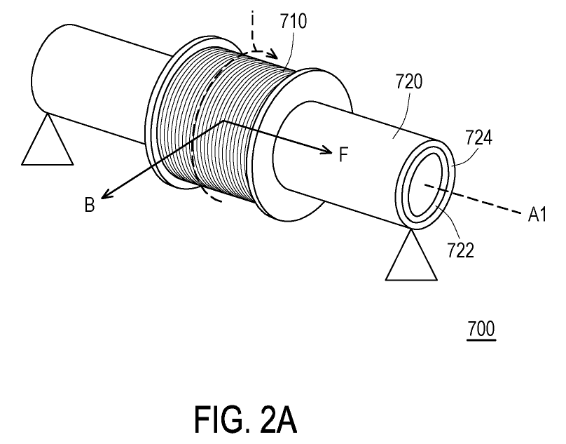

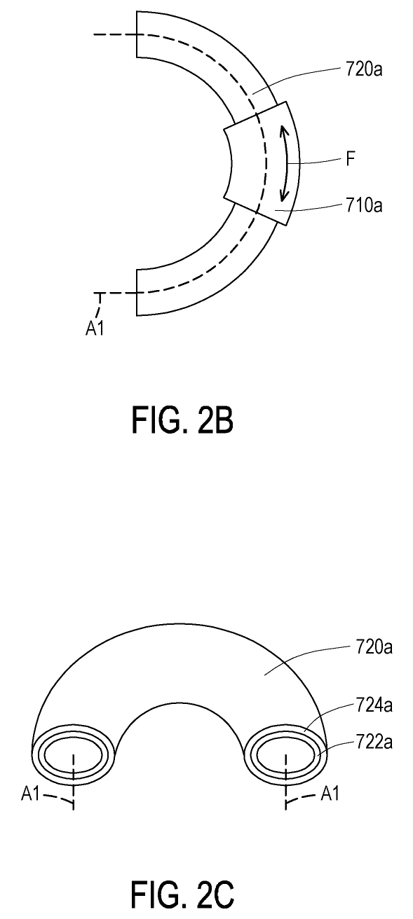

FIGS. 1A and 1B are schematic perspective views of a camera assembly when a camera thereof is rotated to two different angles respectively according to an embodiment of the disclosure. FIG. 2A is a schematic perspective view of a voice coil motor module according to an embodiment of the disclosure. FIG. 2B is a schematic side view of a voice coil motor module according to another embodiment of the disclosure. FIG. 2C is a schematic perspective view of a magnet of the voice coil motor module in FIG. 2B. Referring to FIGS. 1A, 1B, and 2A to 2C, a camera assembly 100 in this embodiment includes a first voice coil motor module 200, a second voice coil motor module 300, a first connector 110, a camera 130, and a second connector 120. The first voice coil motor module 200 includes a first coil 210 and a first magnet 220. The first coil 210 surrounds a portion of a periphery of the first magnet 220, and the first coil 210 is adapted to move along a central axis of the first magnet 220. The second voice coil motor module 300 includes a second coil 310 and a second magnet 320. The second coil 310 surrounds a portion of a periphery of the second magnet 320, and the second coil 310 is adapted to move along a central axis of the second magnet 320. The camera 130 is connected to the first coil 210 through the first connector 110. The second voice coil motor module 300 is connected to the first coil 210 or the first magnet 220 through the second connector 120. In this embodiment, for example, the second coil 310 of the second voice coil motor module 300 is connected to the first coil 210 through the second connector 120. A distance between the first coil 210 and the camera 130 is less than a distance between the second coil 310 and the camera 130.

In FIGS. 2A, 2B, and 2C, a single voice coil motor module is taken as an example to describe operating principles of each of the first voice coil motor module 200 and the second voice coil motor module 300. In FIG. 2A, a voice coil motor module 700 includes a coil 710 and a magnet 720. The magnet 720 is cylindrical, and a direction of a magnetic field B of the magnet 720 is along a radial direction of the magnet 720. For example, the magnet 720 is in a shape of a hollow cylinder and is formed by two inner and outer layers of tubular structures. A magnetic pole of an inner layer 722 of the hollow cylinder is, for example, an S pole, and a magnetic pole of an outer layer 724 of the hollow cylinder is, for example, an N pole. In this way, the direction of the magnetic field B is along a radial direction of the hollow cylinder. Alternatively, in another embodiment, the outer layer 724 may be an S pole, and the inner layer 722 may be an N pole. Alternatively, in other embodiments, the magnet 720 may also be in a shape of a solid cylinder and is formed by an inner central shaft and an outer tubular structure surrounding the central shaft. A magnetic pole of one of the central shaft and the tubular structure of the solid cylinder is an N pole, and a magnetic pole of the other of the central shaft and the tubular structure is an S pole. In an embodiment, the coil 710 includes a hollow ring slidably sleeved on the cylindrical magnet 720 and a multi-turn wire wound around the hollow ring along a circumferential direction of a cylindrical surface of the magnet 720. When a current i is input to the multi-turn wire of the coil 710, if a length of the coil is L, the coil 710 will be affected by the magnetic field B from the magnet 720 and receive thrust F, where F=iLB, and a direction of the thrust F may be known by using the Fleming’s left-hand rule that it is along an axial direction of the magnet 720 (a direction of an arrow marked F in FIG. 2A). If a direction of the input current i is opposite, the thrust received by the coil 710 due to the magnetic field B from the magnet 720 will also be in an opposite direction of F in FIG. 2A. That is to say, when the current is input to the multi-turn wire of the coil 710, the coil 710 will move along a central axis A1 of the magnet 720. In FIGS. 2B and 2C, the magnet 720 in FIG. 2A may also be designed in a curved shape, such as a magnet 720a designed to be arc-shaped as shown in FIGS. 2B and 2C, and a coil 710a may fit a shape of the magnet 720a to form a voice coil motor module 700a. After receiving the thrust F, the coil 710a moves in an arc shape motion along the central axis A1 of the magnet 720a as the magnet 720a bends (as mentioned above, double arrows indicating the thrust F in FIG. 2B indicates that the thrust F will move in opposite directions depending on the direction of the input current). The magnet 720a may be in the shape of the hollow cylinder or a shape of a solid cylinder. A magnetic pole of the central shaft or an inner layer 722a of the magnet 720a is, for example, an S pole. A magnetic pole of a tubular structure or an outer layer 724a of the magnet 720a is, for example, an N pole. Alternatively, in another embodiment, the central shaft or the inner layer 722a of the magnet 720a is, for example, an N pole, and the tubular structure or the outer layer 724a of the magnet 720a is, for example, an S pole. In this embodiment, for example, cross-sections of the outer layer 724a and the inner layer 722a of the magnets 720 and 720a are circular. However, in other embodiments, the cross-sections of the outer layer 724a and the inner layer 722a of the magnets 720 and 720a may also be polygonal, elliptical, or other appropriate geometric shapes.

In this embodiment, structures of the first voice coil motor module 200 and the second voice coil motor module 300 may be similar to the structure of the voice coil motor module 700a in FIG. 2B. The first magnet 220 is cylindrical (such as a hollow column or a solid column). A direction of a magnetic field of the first magnet 220 is along a radial direction of the first magnet 220 (that is, a radial direction of a cross-section of the first magnet 220, which is perpendicular to the central axis of the first magnet 220). The second magnet 320 is cylindrical (such as a hollow column or a solid column). A direction of a magnetic field of the second magnet 320 is along a radial direction of the second magnet 320 (that is, a radial direction of a cross-section of the second magnet 320, which is perpendicular to the central axis of the second magnet 320).

In this embodiment, the first coil 210 is adapted to move along the central axis of the first magnet 220 and move around a first axial direction with the first axial direction (i.e., a direction perpendicular to a plane where the first magnet 220 is located, for example, when the first magnet 220 is arc-shaped and located on an xy plane, at this time, a z-axis in FIG. 1A may be regarded as the first axial direction) as a rotation axis. The second coil 310 is adapted to move along the central axis of the second magnet 320 and move around a second axial direction with the second axial direction (i.e., a direction perpendicular to a plane where the second magnet 320 is located, for example, when the second magnet 320 is arc-shaped and located on an yz plane, at this time, an x-axis in FIG. 1A may be regarded as the second axial direction) as the rotation axis. The first axial direction is perpendicular to the second axial direction. In this embodiment, the x-axis, a y-axis, and the z-axis in FIG. 1A are perpendicular to each other. In addition, in this embodiment, both the first connector 110 and the second connector 120 are rod-shaped.

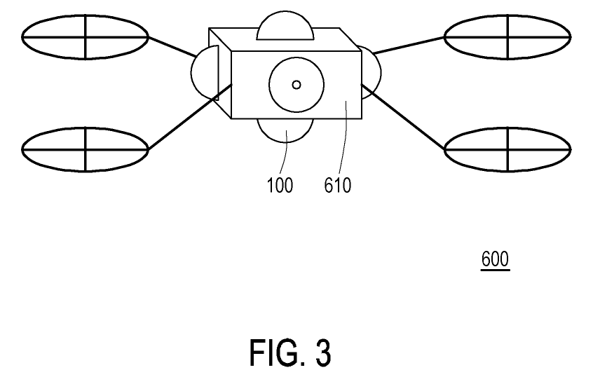

FIG. 3 is a schematic perspective view of an electronic device according to an embodiment of the disclosure. Referring to FIGS. 1A, 1B, and 3, an electronic device 600 in this embodiment includes a carrier 610 and the above camera assembly 100. The carrier 610 may be an unmanned carrier, such as a drone or an unmanned vehicle, and in FIG. 3, the drone is taken as an example. The camera assembly 100 is disposed on the carrier 610. As shown in FIG. 3, the camera assembly 100 may be disposed on at least one surface of upper, lower, left, right, front, and rear surfaces of the carrier 610. In this embodiment, two ends of the first magnet 220 and two ends of the second magnet 320 are respectively connected to universal joints 140 or other hinge mechanisms, and the universal joints 140 or other hinge mechanisms are connected to the carrier 610. In this embodiment, the universal joints 140 or other hinge mechanisms are directly or indirectly fixed to a casing of the carrier 610, but the disclosure is not limited thereto. In this way, the first magnet 220 and the second magnet 320 may swing relative to the carrier 610. That is to say, in addition to the first coil 210 and the second coil 310 that may move along the central axes of the first magnet 220 and the second magnet 320, the first magnet 220, the second magnet 320, and the camera 130 will also swing relative to the carrier 610, so that the camera 130 may face a photographing direction.

In the camera assembly 100 and the electronic device 600 of this embodiment, the first voice coil motor module 200 having the first coil 210 and the first magnet 220 and the second voice coil motor module 300 having the second coil 310 and the second magnet 320 are used. The camera 130 is connected to the first coil 210 through the first connector 110, and the second coil 310 of the second voice coil motor module 300 is connected to the first coil 210 through the second connector 120. In this way, the camera assembly 100 may achieve an effect similar to eyeball rotation, may have a smaller size to reduce overall payload volume of the camera assembly 100, and may even be installed on a drone with a size of a mobile phone. In addition, the camera assembly 100 designed in this way may be controlled by a simpler method and requires less computing capability of a single chip, thereby reducing costs. In this embodiment, control of movements and positions of the first coil 210 and the second coil 310 may be realized by proportional-integral-derivative control (i.e., PID control). A transfer function may be obtained by using a mechanical formula, and by planning a pole-zero point to enable a system to be stable, and the positions of the first coil 210 and the second coil 310 may thus be controlled to reach desired positions. In addition, in order to measure the positions of the first coil 210 and the second coil 310, a strip resistor may be used to be attached on the first magnet 220 and the second magnet 320. By measuring voltage division of the resistor, a position signal may be fed back to a controller, which may achieve positioning control. The controller may perform calculation on the feed-back position signal, or adjust the current provided to the first coil 210 and the second coil 310 again according to a lookup table, and finally adjust the camera 130 to a position where it should originally be.

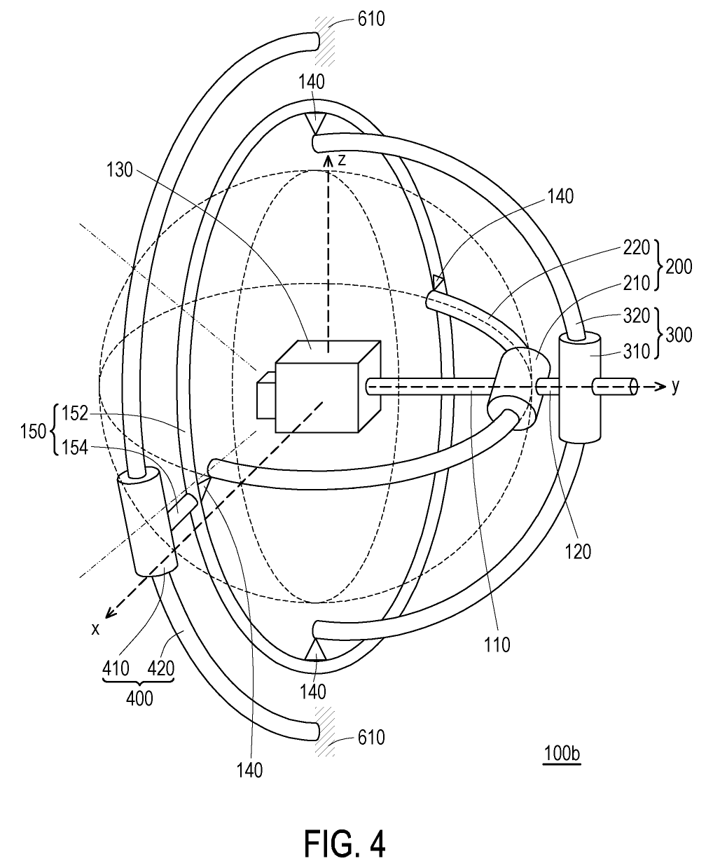

FIG. 4 is a schematic perspective view of a camera assembly according to another embodiment of the disclosure. Referring to FIG. 4, a camera assembly 100b in this embodiment is similar to the camera assembly 100 in FIG. 1A, and main differences between the two are as follows. The camera assembly 100b in this embodiment further includes a third voice coil motor module 400 and a third connector 150. The third voice coil motor module 400 includes a third coil 410 and a third magnet 420. The third coil 410 surrounds a portion of a periphery of the third magnet 420, and the third coil 410 is adapted to move along a central axis of the third magnet 420. In this embodiment, the third coil 410 is adapted to move along the central axis of the third magnet 420 and move around a third axial direction with the third axial direction (i.e., a direction perpendicular to a plane where the third magnet 420 is located, for example, when the third magnet 420 is arc-shaped and located on an xz plane, at this time, the y-axis in FIG. 4 may be regarded as the third axial direction) as the rotation axis. The third connector 150 is connected to the third coil 410. The first magnet 220 is hinged to the third connector 150, and the second magnet 320 is hinged to the third connector 150.

In this embodiment, the third connector 150 includes an annular portion 152 and a rod-shaped portion 154. The rod-shaped portion 154 connects the annular portion 152 with the third coil 410, and the two ends of the first magnet 220 and the two ends of the second magnet 320 are respectively hinged to the annular portion 152 by universal joints 140. In addition, two ends of the third magnet 420 are fixed on the carrier 610. A movement of the third coil 410 on the third magnet 420 may enable the camera 130 to spin around a central axis of the first connector 110 as an axis.

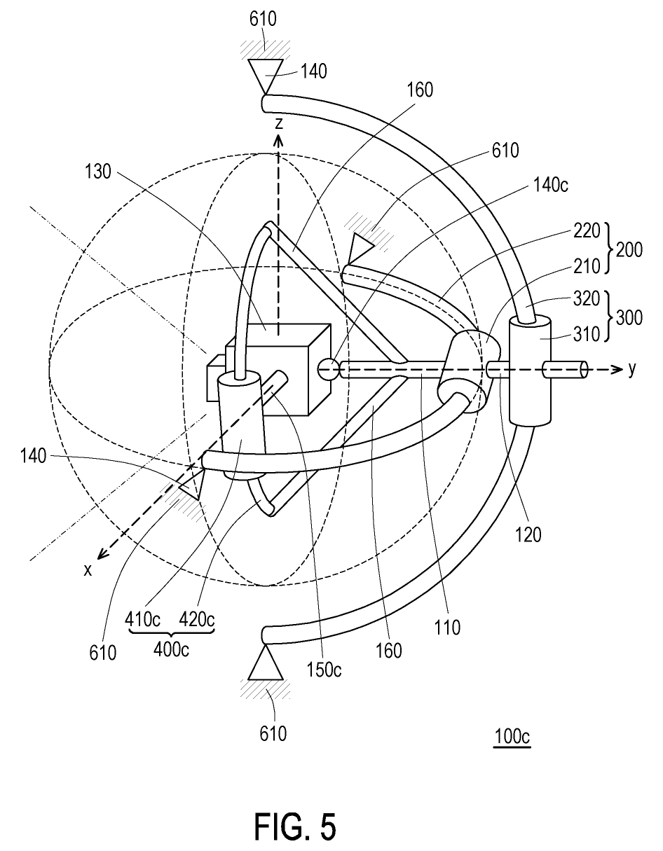

FIG. 5 is a schematic perspective view of a camera assembly according to still another embodiment of the disclosure. Referring to FIG. 5, a camera assembly 100c in this embodiment is similar to the camera assembly 100 in FIG. 1A, and main differences between the two are as follows. The camera assembly 100c in this embodiment further includes a third voice coil motor module 400c, a third connector 150c, and at least one fourth connector 160 (two fourth connectors 160 are taken as an example in FIG. 5). The third voice coil motor module 400c includes a third coil 410c and a third magnet 420c. The third coil 410c surrounds a portion of a periphery of the third magnet 420c, and the third coil 410c is adapted to move along a central axis of the third magnet 420c. The third connector 150c connects the third coil 410c with the camera 130, and the camera 130 is rotatably connected to the first connector 110. For example, the camera 130 is rotatably connected to the first connector 110 through a universal joint 140c. In addition, the fourth connector 160 connects the third magnet 420c with the first connector 110. When the third coil 410c moves on the third magnet 420c, it may drive the camera 130 to spin relative to the first connector 110 around the central axis of the first connector 110 as an axis.

In this embodiment, the two ends of the first magnet 220 and the two ends of the second magnet 320 are respectively connected to the universal joints 140 or other hinge mechanisms, and the universal joints 140 or other hinge mechanisms are connected to the carrier 610. In this embodiment, the universal joints 140 or other hinge mechanisms are directly or indirectly fixed to the casing of the carrier 610, but the disclosure is not limited thereto. In this way, the first magnet 220 and the second magnet 320 may swing relative to the carrier 610.

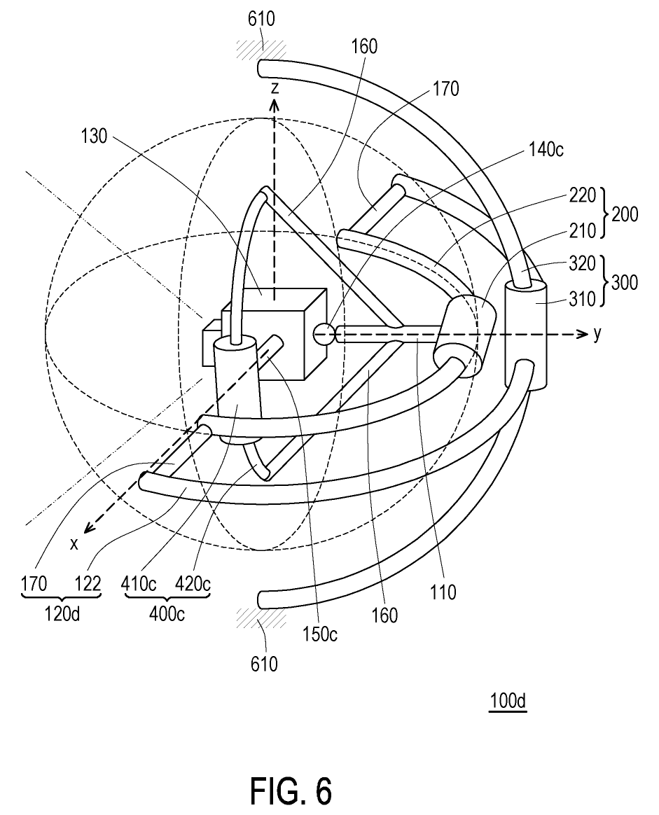

FIG. 6 is a schematic perspective view of a camera assembly according to yet another embodiment of the disclosure. Referring to FIG. 6, a camera assembly 100d in this embodiment is similar to the camera assembly 100c in FIG. 5, and main differences between the two are as follows. In the camera assembly 100d of this embodiment, the second voice coil motor module 300 is connected to the first magnet 220 through a second connector 120d (for example, the second coil 310 of the second voice coil motor module 300 is connected to the first magnet 220 through the second connector 120d). The second connector 120d includes an arc bracket 122, and a center of the first coil 210, the arc bracket 122, and a center of the second coil 310 are coplanar. In this embodiment, the second connector 120d further includes two connecting rods 170, and two ends of the arc bracket 122 are respectively connected to the two ends of the first magnet 220 through the two connecting rods 170. When the second coil 310 moves on the second magnet 320, it will drive the first magnet 220 to swing through the second connector 120d. For example, the second coil 310 and the first coil 210 rotate around the x-axis with the x-axis as the rotation axis. In addition, in this embodiment, the two ends of the second magnet 320 are fixed on the carrier 610.

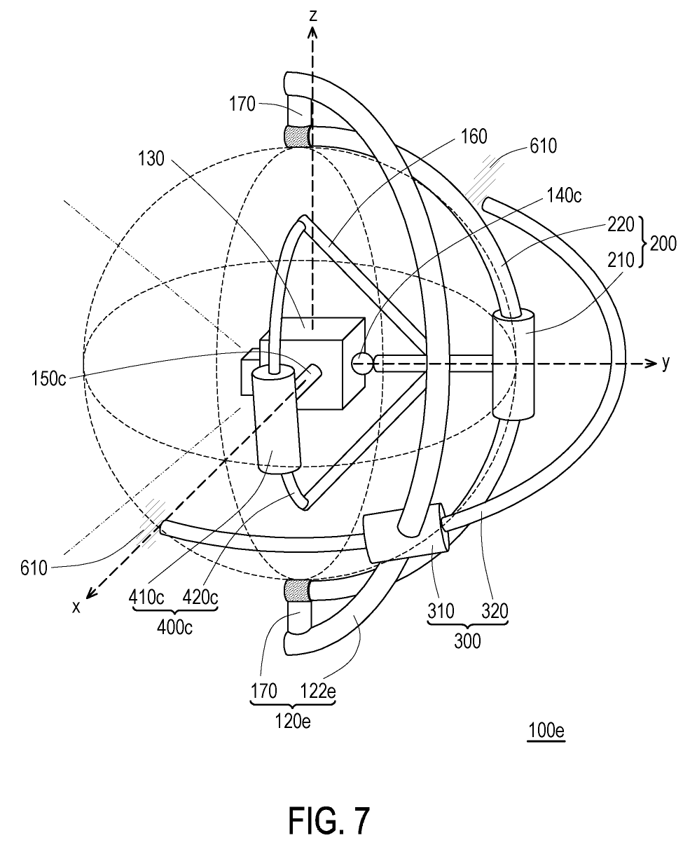

FIG. 7 is a schematic perspective view of a camera assembly according to another embodiment of the disclosure. Referring to FIG. 7, a camera assembly 100e in this embodiment is similar to the camera assembly 100d in FIG. 6, and main differences between the two are as follows. The second voice coil motor module 300 is connected to the first magnet 220 through a second connector 120e (for example, the second coil 310 of the second voice coil motor module 300 is connected to the first magnet 220 through the second connector 120e). The second connector 120e includes an arc bracket 122e, and the center of the first coil 210, the arc bracket 122e, and the center of the second coil 310 are not coplanar. In this embodiment, the second connector 120e further includes the two connecting rods 170, and the two ends of the arc bracket 122e are respectively connected to the two ends of the first magnet 220 through the two connecting rods 170. When the second coil 310 moves on the second magnet 320, it will drive the first magnet 220 to swing through the second connector 120e. For example, the second coil 310 and the first coil 210 rotate around the z-axis with the z-axis as the rotation axis. In addition, in this embodiment, the two ends of the second magnet 320 are fixed on the carrier 610.

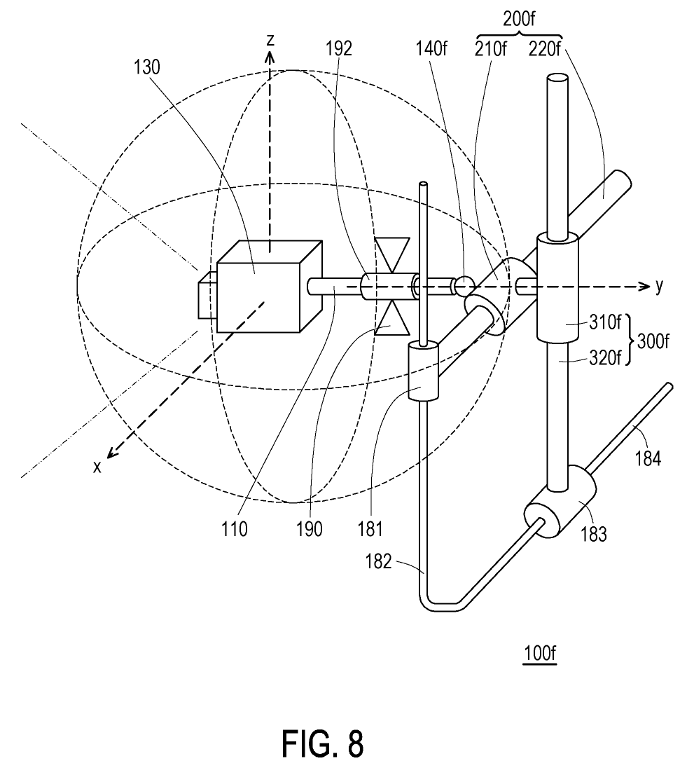

FIG. 8 is a schematic perspective view of a camera assembly according to still another embodiment of the disclosure. Referring to FIG. 8, a camera assembly 100f in this embodiment is similar to the camera assembly 100 in FIG. 1A, and main differences between the two are as follows. The camera assembly 100f in this embodiment further includes a first outer bracket 182, a second outer bracket 184, a first sleeve ring 181, and a second sleeve ring 183. The first sleeve ring 181 is slidably sleeved on the first outer bracket 182. The second sleeve ring 183 is slidably sleeved on the second outer bracket 184. A first magnet 220f is connected to the first sleeve ring 181. A second magnet 320f is connected to the second sleeve ring 183. The first magnet 220f and the second magnet 320f are both rod-shaped (e.g., linear rod-shaped), and the first outer bracket 182 and the second outer bracket 184 are perpendicular to each other. In an embodiment, one end of the first outer bracket 182 may be connected to one end of the second outer bracket 184. In addition, the first connector 110 is rotatably connected to a first coil 210f through a universal joint 140f, and the first connector 110 swings with a support point 190 as a center. In this embodiment, a sleeve ring 192 may be disposed at the support point 190. The first connector 110 may slide in the sleeve ring 192, and the sleeve ring 192 may rotate relative to the support point 190. When the first coil 210f moves on the first magnet 220f, the camera 130 swings toward an +x or -x direction on the xy plane, and when a second coil 310f moves on the second magnet 320f, the camera 130 swings toward a +z or -z direction on the xy plane. A voice coil motor module 200f formed by the first coil 210f and the first magnet 220f and a voice coil motor module 300f formed by the second coil 310f and the second magnet 320f may be implemented by the voice coil motor module 700 in FIG. 2A.

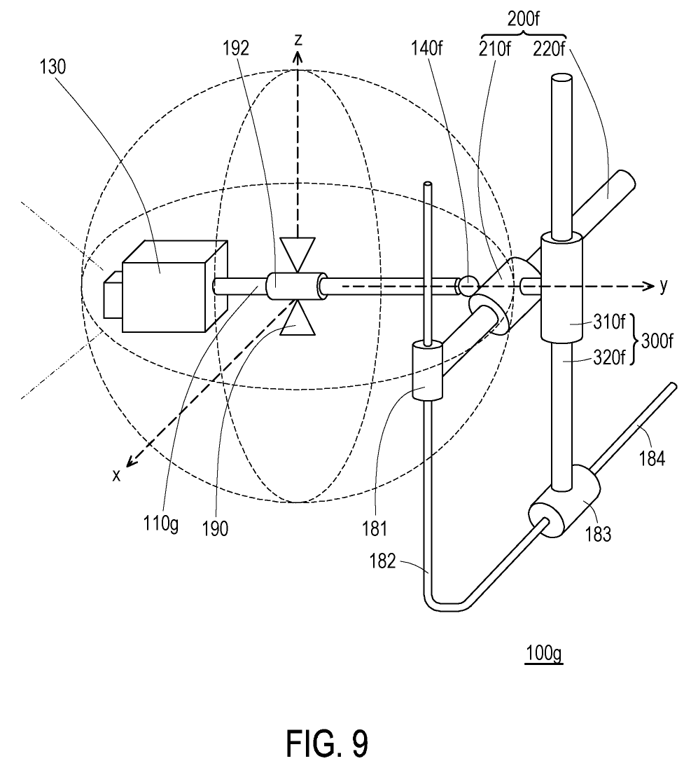

FIG. 9 is a schematic perspective view of a camera assembly according to yet another embodiment of the disclosure. Referring to FIG. 9, a camera assembly 100g in this embodiment is similar to the camera assembly 100f in FIG. 8. A main difference between the two is that a first connector 110g in FIG. 9 is relatively long, so that the camera 130 is not located at a center of a rotating virtual sphere as shown in FIG. 8, but with the motion of the first coil 210f on the first magnet 220f and the motion of the second coil 310f on the second magnet 320f, the camera 130 may move at another end of the first connector 110g as the motion at one end of a seesaw.

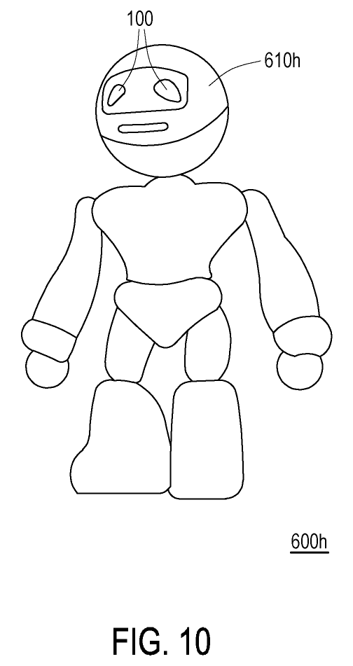

FIG. 10 is a schematic view of an electronic device according to another embodiment of the disclosure. Referring to FIG. 10, an electronic device 600h in this embodiment includes a carrier 610h and the camera assembly 100 as shown in FIG. 1A. The camera assembly 100 is located on the carrier 610h. In this embodiment, the carrier 610h is a robot. The number of camera assemblies 100 is, for example, two, and the two camera assemblies 100 serve as two eyes of the robot respectively. In this way, the two camera assemblies 100 may simulate human eyes and be used in a humanoid robot. In addition, in another embodiment, the two camera assemblies 100 may also simulate fish eyes and be used in an underwater machine. That is, the carrier may also be a submarine or other electronic device.

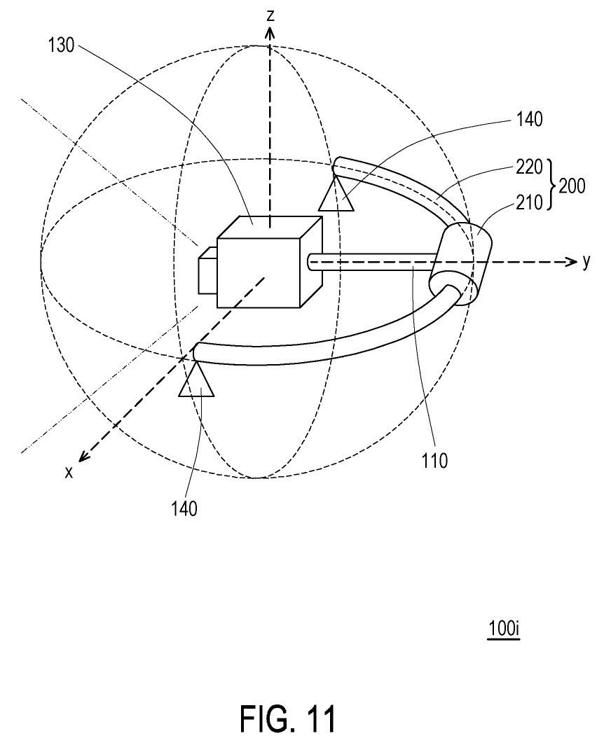

FIG. 11 is a schematic perspective view of a camera assembly according to another embodiment of the disclosure. A camera assembly 100i in this embodiment is similar to the camera assembly 100 in FIG. 1A, and a main difference between the two is that the camera assembly 100i in this embodiment does not have the second voice coil motor module 300 and the second connector 120 in FIG. 1A. The camera assembly 100i in this embodiment may also achieve rotation of the camera 130 in one dimension through the first voice coil motor module 200 and the first connector 110, so that it may have a smaller size and may be controlled by a simpler method. Alternatively, in an embodiment, in addition to the first voice coil motor module 200, the camera assembly 100i may also be matched with other types of motors (e.g., a brushless motor or other types of motors). Although other types of motors may take up more space or be more difficult to control, due to the use of the first voice coil motor module 200, the size may be partially saved, and the control may be partially simplified. In this embodiment, although the first voice coil motor module 200 having the arc magnet 220 similar to that in FIG. 1A is taken as an example, the disclosure is not limited thereto. In another embodiment, the first voice coil motor module 200f having the rod-shaped magnet 220f similar to that in FIGS. 2A and 8 may also be used. In other embodiments not shown in the disclosure, a combination of both the voice coil motor module having the arc magnet and the voice coil motor module having the rod-shaped magnet may also be used. For example, the arc magnet is used for the first voice coil motor uses, and the rod-shaped magnet is used for the second voice coil motor.

Based on the above, the camera assembly and the electronic device in the embodiments of the disclosure have at least one of the following advantages. In the camera assembly and the electronic device in the embodiments of the disclosure, the first voice coil motor having the first coil and the first magnet is used, and the camera is connected to first coil through the first connector. In this way, the camera assembly may have a smaller size and may be controlled by the simpler method.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A camera assembly, comprising:
a first voice coil motor module comprising a first coil and a first magnet, wherein the first coil surrounds a portion of a periphery of the first magnet, and the first coil is adapted to move along a central axis of the first magnet;
a first connector; and
a camera connected to the first coil through the first connector.

2. The camera assembly according to claim 1, wherein the first magnet is cylindrical, and a direction of a magnetic field of the first magnet is along a radial direction of the first magnet.

3. The camera assembly according to claim 1, further comprising:
a second voice coil motor module comprising a second coil and a second magnet, wherein the second coil surrounds a portion of a periphery of the second magnet, and the second coil is adapted to move along a central axis of the second magnet; and
a second connector, wherein the second voice coil motor module is connected to the first coil or the first magnet through the second connector, and a distance between the first coil and the camera is less than a distance between the second coil and the camera.

4. The camera assembly according to claim 3, wherein the first coil is adapted to move around a first axial direction, the second coil is adapted to move around a second axial direction, and the first axial direction is perpendicular to the second axial direction.

5. The camera assembly according to claim 3, wherein the first magnet is cylindrical, a direction of a magnetic field of the first magnet is along a radial direction of the first magnet, the second magnet is cylindrical, and a direction of a magnetic field of the second magnet is along a radial direction of the second magnet.

6. The camera assembly according to claim 3, further comprising:
a third voice coil motor module comprising a third coil and a third magnet, wherein the third coil surrounds a portion of a periphery of the third magnet, and the third coil is adapted to move along a central axis of the third magnet; and
a third connector connected to the third coil, wherein the first magnet is pivoted to the third connector, and the second magnet is pivoted to the third connector.

7. The camera assembly according to claim 3, further comprising:
a third voice coil motor module comprising a third coil and a third magnet, wherein the third coil surrounds a portion of a periphery of the third magnet, and the third coil is adapted to move along a central axis of the third magnet;
a third connector connecting the third coil with the camera, wherein the camera is rotatably connected to the first connector; and
at least one fourth connector connecting the third magnet with the first connector.

8. The camera assembly according to claim 3, wherein the second voice coil motor module is connected to the first magnet through the second connector, the second connector comprises an arc bracket, and a center of the first coil, the arc bracket, and a center of the second coil are coplanar.

9. The camera assembly according to claim 3, wherein the second voice coil motor module is connected to the first magnet through the second connector, the second connector comprises an arc bracket, and a center of the first coil, the arc bracket, and a center of the second coil are not coplanar.

10. The camera assembly according to claim 3, wherein two ends of the first magnet and two ends of the second magnet are connected to universal joints respectively.

11. The camera assembly according to claim 3, further comprising a first outer bracket, a second outer bracket, a first sleeve ring, and a second sleeve ring, wherein the first sleeve ring is slidably sleeved on the first outer bracket, the second sleeve ring is slidably sleeved on the second outer bracket, the first magnet is connected to the first sleeve ring, the second magnet is connected to the second sleeve ring, the first magnet and the second magnet are both rod-shaped, and the first outer bracket and the second outer bracket are perpendicular to each other.

12. The camera assembly according to claim 11, wherein the first connector is configured to swing with a support point as a center.

13. An electronic device, comprising:
a carrier; and
a camera assembly disposed on the carrier and comprising:
a first voice coil motor module comprising a first coil and a first magnet, wherein the first coil surrounds a portion of a periphery of the first magnet, and the first coil is adapted to move along a central axis of the first magnet;
a first connector; and
a camera connected to the first coil through the first connector.

14. The electronic device according to claim 13, wherein the first magnet is cylindrical, and a direction of a magnetic field of the first magnet is along a radial direction of the first magnet.

15. The electronic device according to claim 13, wherein the camera assembly further comprises:
a second voice coil motor module comprising a second coil and a second magnet, wherein the second coil surrounds a portion of a periphery of the second magnet, and the second coil is adapted to move along a central axis of the second magnet; and
a second connector, wherein the second voice coil motor module is connected to the first coil or the first magnet through the second connector, and a distance between the first coil and the camera is less than a distance between the second coil and the camera.

16. The electronic device according to claim 15, wherein the first coil is adapted to move around a first axial direction, the second coil is adapted to move around a second axial direction, and the first axial direction is perpendicular to the second axial direction.

17. The electronic device according to claim 15, wherein the first magnet is cylindrical, a direction of a magnetic field of the first magnet is along a radial direction of the first magnet, the second magnet is cylindrical, and a direction of a magnetic field of the second magnet is along a radial direction of the second magnet.

18. The electronic device according to claim 15, wherein the camera assembly further comprises:
a third voice coil motor module comprising a third coil and a third magnet, wherein the third coil surrounds a portion of a periphery of the third magnet, and the third coil is adapted to move along a central axis of the third magnet; and
a third connector connected to the third coil, wherein the first magnet is pivoted to the third connector, and the second magnet is pivoted to the third connector.

19. The electronic device according to claim 15, wherein the camera assembly further comprises:
a third voice coil motor module comprising a third coil and a third magnet, wherein the third coil surrounds a portion of a periphery of the third magnet, and the third coil is adapted to move along a central axis of the third magnet;
a third connector connecting the third coil with the camera, wherein the camera is rotatably connected to the first connector; and
at least one fourth connector connecting the third magnet with the first connector.

20. The electronic device according to claim 15, wherein the second voice coil motor module is connected to the first magnet through the second connector, the second connector comprises an arc bracket, and a center of the first coil, the arc bracket, and a center of the second coil are coplanar.

21. The electronic device according to claim 15, wherein the second voice coil motor module is connected to the first magnet through the second connector, the second connector comprises an arc bracket, and a center of the first coil, the arc bracket, and a center of the second coil are not coplanar.

22. The electronic device according to claim 15, wherein two ends of the first magnet and two ends of the second magnet are connected to universal joints respectively.

23. The electronic device according to claim 15, wherein the camera assembly further comprises a first outer bracket, a second outer bracket, a first sleeve ring, and a second sleeve ring, wherein the first sleeve ring is slidably sleeved on the first outer bracket, the second sleeve ring is slidably sleeved on the second outer bracket, the first magnet is connected to the first sleeve ring, the second magnet is connected to the second sleeve ring, the first magnet and the second magnet are both rod-shaped, and the first outer bracket and the second outer bracket are perpendicular to each other.

24. The electronic device according to claim 23, wherein the first connector is configured to swing with a support point as a center.

25. The electronic device according to claim 13, wherein the carrier is an unmanned carrier or a robot.
